(19) United States
(12) Patent Application Publication
(10) Pub. No.: US 2025/0381534 A1
(43) Pub. Date: Dec. 18, 2025

(54) A ROTOR BLADE INTENDED FOR A ROTOR IN A MIXER AND A ROTOR-STATOR SYSTEM

(71) Applicant: SANSO MIXING AB, HÖRBY (SE)

(72) Inventors: Nemo IVARSSON, Stockholm (SE); Mats ANDERSSON, ESLÖV (SE)

(21) Appl. No.: 19/130,206

(22) PCT Filed: Nov. 14, 2023
(86) PCT No.: PCT/SE2023/051156

§ 371 Date: May 15, 2025

(30) Foreign Application Priority Data
Nov. 16, 2022 (SE) 2251344-4

(51) Int. Cl. B01F 27/1125; B01F 27/1124; B01F 27/272

(52) U.S. Cl. CPC B01F 27/1125; B01F 27/1124; B01F 27/272; B01F 2215/0422; B01F 2215/0431

(57) ABSTRACT

The present invention describes a rotor blade (1) intended for a rotor in a mixer, said rotor blade (1) having a main body (2) and multiple rotor wings (3) extending out from one side of the main body (2), wherein there is provided a gap (10) between each pair of rotor wings (3), and wherein the gap (10) extends outwards towards a peripheral part of the rotor blade (1) in an angled or bent surface (100) in relation to a horizontal plane of the main body (2) of the rotor blade (1). The invention also describes rotor-stator system.

### FIELD OF THE INVENTION

The present invention relates to a rotor blade intended for a rotor in a mixer, and to a rotor-stator system in a mixer.

### SUMMARY OF THE INVENTION

The present invention is directed to a rotor blade intended for a rotor in a mixer, said rotor blade having a main body and multiple rotor wings extending out from one side of the main body, wherein there is provided a gap between each pair of rotor wings, and wherein the gap extends outwards towards a peripheral part of the rotor blade in an angled or bent surface in relation to a horizontal plane of the main body of the rotor blade. Preferably each gap extends outwards towards a peripheral part of the rotor blade in an angled or bent surface.

The rotor blade according to the present invention is intended for a rotor in a rotor-stator system for a mixer. The mixer may be used for many different types of materials, such as for mixing different phase materials, e.g. one liquid phase with one solid phase. Furthermore, the rotor blade according to the present invention is also suitable for the mixing and processing of difficult materials, such as for mixing a powder with a liquid for the production of granules. One type of interest for the present invention is materials containing starch.

The present invention is directed to providing an optimal geometry between the rotor wings. This geometry ensures a suitable transfer from the rotor into a stator and then out from the mixer for the material being processed in the rotor. Although only presenting examples, the concept according to the present invention will be further understood from the embodiments provided below and the attached drawings. Specific embodiments of the invention

Below some specific embodiments of the present invention are provided.

According to one embodiment, each gap extends outwards towards a peripheral part of the rotor blade in an angled or bent surface.

According to one embodiment, the angled or bent surface extends in an overlapping surface which is intended as an overlap between the rotor blade when being connected to a stator part comprising a cone or cylinder.

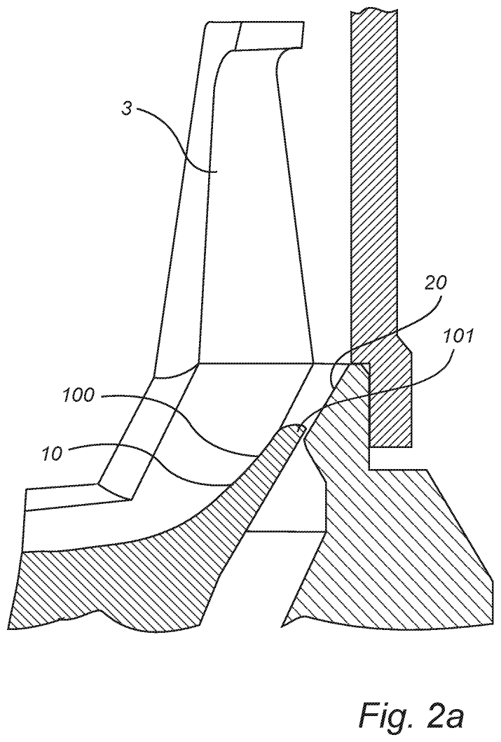

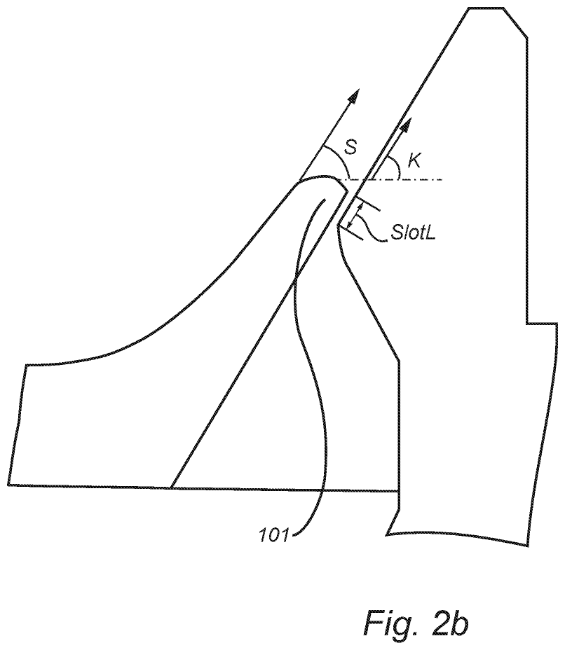

According to yet another embodiment, the overlapping surface has a length in a range of above 0 mm and maximum 55 mm, preferably in a range of above 0 mm and maximum 20 mm, more preferably in range of above 0 mm and maximum 10 mm. This length may also be understood from the enclosed figures. In this context, it may be mentioned that a rotor-stator slot length (see SlotL in FIG. 2b) may be seen as a corresponding length on the underside of the overlapping surface.

Furthermore, there may also be other means included to enable for e.g. addition of water or other liquid solutions. In line with this, according to one embodiment, the overlapping surface comprises a channel, preferably the channel is provided in a close proximity to an end of the angled or bent surface. This channel may be provided for enabling of water addition. Moreover, water may also be added via the rotor-stator slot.

Furthermore, according to one embodiment, the angled or bent surface is angled or bent upwards in relation to a horizontal plane of the main body of the rotor blade. This may be of interest to ensure a further vertical spraying angle out from the rotor blade. It should be noted that this the relationship between this spraying angle and a corresponding angle on the stator side is one important aspect. This is further discussed below.

Moreover, according to yet another embodiment, the angled or bent surface has at least a concave portion in proximity to the overlapping surface. This may also be a way for ensuring a more vertical spraying angle.

Also the rotor wings are one aspect of rotor blades according to the present invention.

According to one embodiment, each of the multiple rotor wings has a protrusion provided along the extension of said at least one rotor wing, wherein, in a front side of the rotor wing in a rotational direction, said at least one rotor wing extends through a point A₂ being a point furthest away from the rotational direction and further up extends through a point A₁ being a point furthest into the rotation direction, and wherein the point A₁ is provided as a most vertical top end point of the protrusion or at least in a horizontal top end plane of the protrusion.

Furthermore, the rotor wings may have different shape. According to one embodiment, said at least one rotor wing extends through the point A₂ being a point furthest away from a rotational direction and further up extends through the point A₁ being a point furthest into the rotation direction, said points A₂ and A₁ having a distance A between each other so that A>0. According to yet another embodiment, the protrusion is at an end of said at least one rotor wing. Moreover, according to one embodiment, the end of the protrusion has a thickness C, extending from a bottom point B₂ to the top point, preferably to a top point A₁ being a point furthest into the rotation direction, preferably wherein C is in the range of 3-30 mm. Furthermore, according to one embodiment, the top point A₁ is further into the rotation direction than the bottom point B₂ of the end of the protrusion, which implies that the end of the protrusion is inclined or bent outwards in the rotational direction, seen from the bottom point B₂ and up to the top point A₁. Moreover, according to yet another embodiment, the bottom point B₂ and the top point A₁ defines and angle B° with an imaginary perpendicular end of the protrusion, and wherein angle B° is in the range of from −15° to 60°. According to yet another embodiment, there is provided an end surface arranged from the top point A₁ to the bottom point B₂ of the end, and wherein the end surface has an inclination or is concave, preferably is inclined. Moreover, according to yet another embodiment, the height H of said at least one rotor wing extends from said one side of the main body of the rotor blade and to the top of said at least one rotor wing, preferably wherein the top is in a point A₁ being a point furthest into the rotation direction, wherein H is at least 2*A, preferably wherein A/H is in a range of 1/50-2/5, more preferably wherein A/H is in a range of 1/25-1/5, most preferably A is maximum 300 mm. According to yet another embodiment of the present invention, the height H of said at least one rotor wing extends from said one side of the main body of the rotor blade and to the top of said at least one rotor wing, and wherein H is less than D where D is the diameter of the main body of the rotor blade, preferably H is at most D/2.

Moreover, according to yet another embodiment, the protrusion is provided as a hook extension at an end of said at least one rotor wing, said hook extension implying that said at least one rotor wing extends with a non-perpendicular angle from the main body in a direction pointing away from the rotational direction, somewhere along the extension of said at least one rotor wing, and then bends back in the rotational direction to provide for the hook extension in the rotational direction.

Furthermore, according to one embodiment, said multiple rotor wings extend from an outer periphery of the main body, said main body preferably being circular. Moreover, according to yet another embodiment, said multiple rotor wings extend perpendicular from a geometrical XY coordinate plane of said one side of the main body or extend with an angle ax in a X direction and/or an angle ay in the Y direction from a totally perpendicular extension from the geometrical XY coordinate plane of said one side of the main body.

The present invention is also directed to a rotor-stator system comprising a rotor blade intended for a rotor in a mixer, said rotor blade having a main body and multiple rotor wings extending out from one side of the main body, wherein there is provided a gap between each pair of rotor wings, wherein the gap provides a surface extending in an overlapping surface which functions as a separate but overlapping surface of the rotor blade in relation to a cone or cylinder of a stator part of the rotor-stator system.

According to one embodiment, the overlapping surface has a length in a range of above 0 mm and maximum 55 mm, preferably in a range of above 0 mm and maximum 20 mm, more preferably in range of above 0 mm and maximum 10 mm. Moreover, according to yet another embodiment, the overlapping surface comprises a channel, preferably the channel is provided in a close proximity to an end of the angled or bent surface.

The present invention is also directed to a rotor-stator system comprising a rotor blade intended for a rotor in a mixer, said rotor blade having a main body and multiple rotor wings extending out from one side of the main body, wherein there is provided a gap between each pair of rotor wings, wherein the gap provides a surface extending in an overlapping surface which functions as a separate but overlapping surface of the rotor blade in relation to a cone or cylinder of a stator part of the rotor-stator system, wherein
S is a spraying angle out from the overlapping surface;
K is a direction angle of the cone or cylinder; and wherein a difference of angle S and angle K to each other is maximum 60 degrees, preferably maximum 45 degrees, more preferably maximum 30 degrees, most preferably maximum 20 degrees.

As should be understood from above, an S angle out from the overlapping surface and over into the direction angle of the cone or cylinder that correspond or at least do not differ too much is a key aspect of the present invention. Furthermore, it should be noted that the difference of the angles S and K should be understood to be in absolute terms, i.e. one or both of these angles may be a negative angle in relation to a given reference.

Moreover, as it is the relationship between these angles that is key, the receiving part of the stator may be more or less vertical, i.e. everything from a cone to a cylinder. Furthermore, the angles may be provided so that the spraying is performed upwards or downwards depending on suitability of the rest of the system. The difference of the angles may also differ based on the material being mixed.

According to yet another embodiment, V is an angle difference for a material being mixed when leaving the angled or bent surface of the rotor blade and entering into a surface of the cone or cylinder of the stator part, wherein V=K−S; and wherein −30°<V<30°.

Moreover, according to one embodiment, there is arranged a rotor-stator slot between the overlapping surface of the rotor blade on an underside of the rotor blade and the cone or cylinder of a stator part, and preferably wherein the rotor-stator slot has a length of 20 mm, preferably maximum 15 mm, most preferably maximum 10 mm. This length is shown as “SlotL” in FIG. 2b.

Furthermore, according to yet another embodiment, the rotor-stator slot is arranged to extend into a geometrical expansion. To have a short rotor-stator slot which extends into some form of geometrical expansion is relevant to minimize the risk of fouling or hardening of material on the surface. Such accumulation of material on the surface is a risk when e.g. starch materials are being processed or mixed. This in turn implies that clogging may be obtained in the slot and then the processing may be disturbed. The provision of a geometrical expansion in said mention slot is relevant to minimize the risk of the clogging.

According to one embodiment, the rotor blade has a center unit intended for connecting the rotor blade to a rotor in a mixer.

### DETAILED DESCRIPTION OF THE DRAWINGS

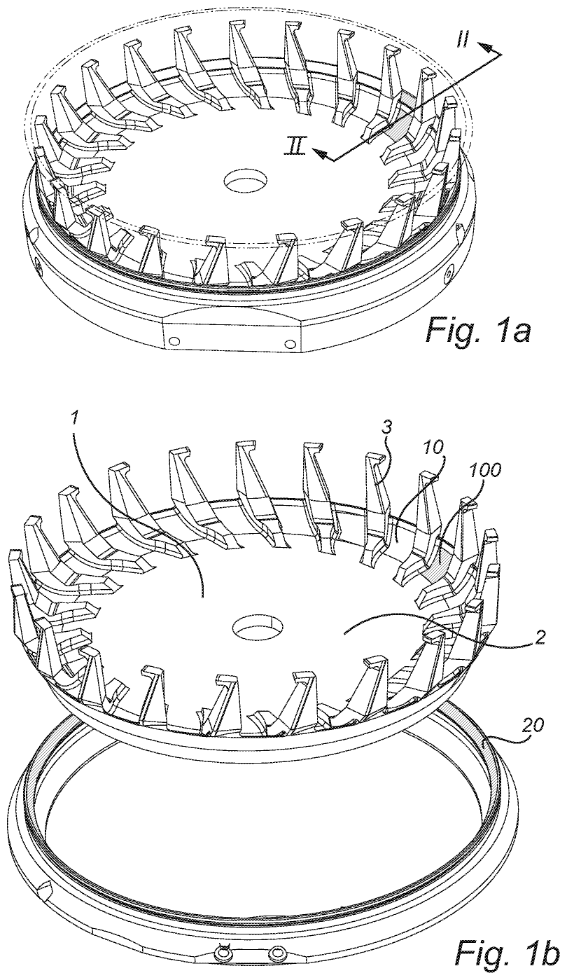

In FIGS. 1a and 1b there are shown one embodiment of a rotor-stator system according to the present invention. The rotor blade 1 comprises a main body 2 and multiple rotor wings 3 extending out from one side of the main body 2, where there is provided gaps 10 between each pair of rotor wings 3, and where the gaps 10 extends outwards towards a peripheral part of the rotor blade 1 in an angled or bent surface 100 (see FIG. 2a). The system also comprises a cone or cylinder 20 of a stator part of the rotor-stator system. It should be noted that the rotor-stator should also be connected to other parts of the system, such as a framework where an intended outflow is defined. This outflow may be of many different types, such as only one opening or a grid with several openings.

In FIG. 2a there is shown a cross section of part of a rotor-stator system according to one embodiment of the present invention. In this case, a rotor wing 3 is shown. The gap 10 has a surface 100 extending in an overlapping surface 101 which functions as a separate but overlapping surface of the rotor blade 1 in relation to a cone or cylinder 20 of a stator part of the rotor-stator system.

In FIG. 2b there is shown another view of minor part of a rotor-stator system according to one embodiment of the present invention. In this case only a minor part of gap 10 provided between a pair of rotor wings 3 is shown. The gap 10 has a surface 100 (see FIG. 2 a) extending in an overlapping surface 101 which is an overlapping surface of the rotor blade 1 in relation to a cone or cylinder 20 of a stator part of the rotor-stator system, and wherein there is provided a slot between the overlapping surface 101 and the other side being the cone or cylinder 20 of the stator part. As seen, the slot has a length shown as SlotL. Moreover, S is a spraying angle out from the overlapping surface 100, K is a direction angle of the cone or cylinder 20. According to the present invention, a difference of angle S and angle K to each other is maximum 60 degrees.

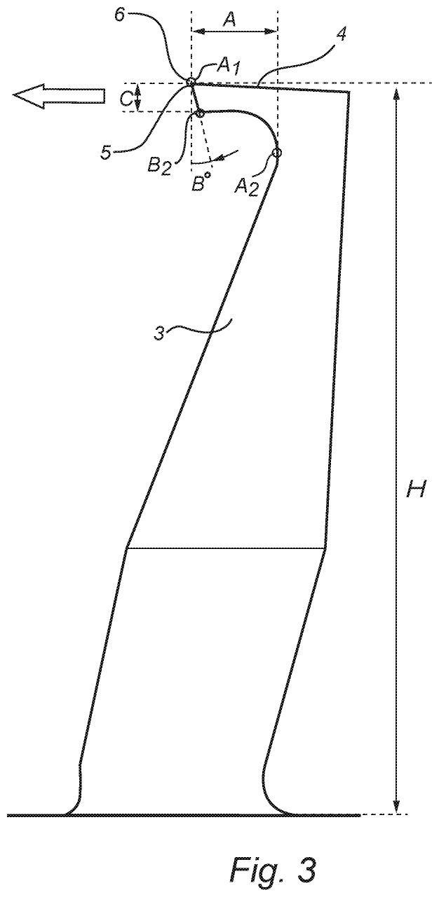

In FIG. 3 there is shown a rotor wing 3 which is a potential part of the rotor blade according to one embodiment of the present invention. The rotor wing 3 has a protrusion 4 provided along the extension of said at least one rotor wing 3. As may be seen, in a front side of the rotor wing 3 in a rotational direction, said at least one rotor wing 3 extends through a point A₂ being a point furthest away from the rotational direction and further up extends through a point A₁ being a point furthest into the rotation direction, and wherein the point A₁ in this case is provided as a most vertical top end point of the protrusion 4. Furthermore, in this case said points A₂ and A₁ has a distance A between each other so that A>0. Moreover, the rotor wing also has a top 6. Furthermore, according to this embodiment, the end 5 of the protrusion 4 has a thickness C, extending from a bottom point B₂ to the top point, and in this case to a top point A₁ being a point furthest into the rotation direction.

Moreover, in this embodiment, the bottom point B₂ and the top point A₁ defines and angle B° with an imaginary perpendicular end 5 of the protrusion 4. Furthermore, the height H of said at least one rotor wing 3 extends from one side of the main body 2 of the rotor blade 1 and to the top 6 of said at least one rotor wing 3, wherein H is at least 2*A.

1. A rotor blade intended for a rotor in a mixer, said rotor blade having a main body and multiple rotor wings extending out from one side of the main body, wherein there is provided a gap between each pair of rotor wings, and wherein the gap extends outwards towards a peripheral part of the rotor blade in an angled or bent surface in relation to a horizontal plane of the main body of the rotor blade.

2. The rotor blade according to claim 1, wherein each gap extends outwards towards a peripheral part of the rotor blade in an angled or bent surface.

3. The rotor blade according to claim 1, wherein the angled or bent surface extends in an overlapping surface which is intended as an overlap between the rotor blade when being connected to a stator part comprising a cone or cylinder .

4. The rotor blade according to claim 3, wherein the overlapping surface has a length in a range of above 0 mm and maximum 55 mm, preferably in a range of above 0 mm and maximum 20 mm, more preferably in range of above 0 mm and maximum 10 mm.

5. The rotor blade according to claim 3 , wherein the overlapping surface comprises a channel, preferably the channel is provided in a close proximity to an end of the angled or bent surface.

6. The rotor blade according to claim 1, wherein the angled or bent surface is angled or bent upwards in relation to a horizontal plane of the main body of the rotor blade.

7. The rotor blade according to claim 3, wherein the angled or bent surface has at least a concave portion in proximity to the overlapping surface.

8. The rotor blade according to claim 1, wherein each of the multiple rotor wings has a protrusion provided along the extension of said at least one rotor wing, wherein, in a front side of the rotor wing in a rotational direction, said at least one rotor wing extends through a point A₂ being a point furthest away from the rotational direction and further up extends through a point A₁ being a point furthest into the rotation direction, and wherein the point A₁ is provided as a most vertical top end point of the protrusion or at least in a horizontal top end plane of the protrusion.

9. The rotor blade according to claim 8, wherein said at least one rotor wing extends through the point A₂ being a point furthest away from a rotational direction and further up extends through the point A₁ being a point furthest into the rotation direction, said points A₂ and A₁ having a distance A between each other so that A>0, and/or wherein the protrusion is at an end of said at least one rotor wing.

10. (canceled)

11. The rotor blade according to claim 9, wherein the end of the protrusion has a thickness C, extending from a bottom point B₂ to the top point, preferably to a top point A₁ being a point furthest into the rotation direction, preferably wherein C is in the range of 3-30 mm, preferably the top point A₁ is further into the rotation direction than the bottom point B₂ of the end of the protrusion, which implies that the end of the protrusion is inclined or bent outwards in the rotational direction, seen from the bottom point B₂ and up to the top point A₁, preferably the bottom point B₂ and the top point A₁ defines and angle B° with an imaginary perpendicular end of the protrusion, and wherein angle B° is in the range of from −15° to 60°.

12. (canceled)

13. (canceled)

14. The rotor blade according to claim 8, wherein there is provided an end surface arranged from the top point A₁ to a bottom point B₂ of the end, and wherein the end surface has an inclination or is concave, preferably is inclined, and/or wherein the height H of said at least one rotor wing extends from said one side of the main body of the rotor blade and to the top of said at least one rotor wing, preferably wherein the top is in a point A₁ being a point furthest into the rotation direction, wherein H is at least 2*A, preferably wherein A/H is in a range of 1/50-2/5, more preferably wherein A/H is in a range of 1/25-1/5, most preferably A is maximum 300 mm, and/or wherein the height H of said at least one rotor wing extends from said one side of the main body of the rotor blade and to the top of said at least one rotor wing, and wherein H is less than D where D is the diameter of the main body of the rotor blade, preferably H is at most D/2.

15. (canceled)

16. (canceled)

17. The rotor blade according to claim 8, wherein the protrusion is provided as a hook extension at an end of said at least one rotor wing, said hook extension implying that said at least one rotor wing extends with a non-perpendicular angle from the main body in a direction pointing away from the rotational direction, somewhere along the extension of said at least one rotor wing, and then bends back in the rotational direction to provide for the hook extension in the rotational direction.

18. The rotor blade according to claim 1, wherein said multiple rotor wings extend from an outer periphery of the main body, said main body preferably being circular.

19. The rotor blade according to claim 1, wherein said multiple rotor wings extend perpendicular from a geometrical XY coordinate plane of said one side of the main body or extend with an angle ax in a X direction and/or an angle ay in the Y direction from a totally perpendicular extension from the geometrical XY coordinate plane of said one side of the main body.

20. A rotor-stator system comprising a rotor blade intended for a rotor in a mixer, said rotor blade having a main body and multiple rotor wings extending out from one side of the main body, wherein there is provided a gap between each pair of rotor wings, wherein the gap provides a surface extending in an overlapping surface which functions as a separate but overlapping surface of the rotor blade in relation to a cone or cylinder of a stator part of the rotor-stator system.

21. The rotor-stator system according to claim 20, wherein the overlapping surface has a length in a range of above 0 mm and maximum 55 mm, preferably in a range of above 0 mm and maximum 20 mm, more preferably in range of above 0 mm and maximum 10 mm.

22. The rotor-stator system according to claim 20, wherein the overlapping surface comprises a channel, preferably the channel is provided in a close proximity to an end of the angled or bent surface.

23. The rotor-stator system according to claim 20, wherein
S is a spraying angle out from the overlapping surface;
K is a direction angle of the cone or cylinder; and wherein a difference of angle S and angle K to each other is maximum 60 degrees, preferably maximum 45 degrees, more preferably maximum 30 degrees, most preferably maximum 20 degrees,
and/or wherein
V is an angle difference for a material being mixed when leaving the angled or bent surface of the rotor blade and entering into a surface of the cone or cylinder of the stator part, wherein V=K−S; and
wherein −30°<V<30°.

24. The rotor-stator system according to claim 20, with a rotor blade according to claim 1.

25. (canceled)

26. The rotor-stator system according to claim 20, wherein there is arranged a rotor-stator slot between the overlapping surface of the rotor blade on an underside of the rotor blade and the cone or cylinder of a stator part, and preferably wherein the rotor-stator slot has a length of 20 mm, preferably maximum 15 mm, most preferably maximum 10 mm, preferably the rotor-stator slot is arranged to extend into a geometrical expansion.

27. (canceled)

28. (canceled)
